(19) United States
(12) Patent Application Publication
(10) Pub. No.: US 2010/0068454 A1
(43) Pub. Date: Mar. 18, 2010

(54) RUBBER DOME AND MANUFACTURING METHOD THEREOF

(76) Inventors: Chien-Shih Hsu, Taipei City (TW); Hong-Yi Huang, Taipei City (TW); Liang-Ta Yeh, Shulin City (TW)

Correspondence Address: PATTERSON & SHERIDAN, LLP - - - IPTEC, 3040 Post Oak Boulevard, Suite 1500, Houston, TX, 77056-6582, US

(21) Appl. No.: 12/557,171

(22) Filed: Sep. 10, 2009

(30) Foreign Application Priority Data
Sep. 12, 2008 (TW) 097135234

(51) Int. Cl. B28B 1/14; B29C 39/02

(52) U.S. Cl. 428/132; 264/299

(57) ABSTRACT

A rubber dome is disclosed in this invention. The rubber dome includes a rubber body and a hole. When the bottom of a first mold and the top of a second mold are closely connected, a specific space is generated between them. After a rubber material is poured into the specific space, the rubber material will form the rubber body. When the first mold and the second mold are separated, the hole will be automatically formed on the top of the rubber body.

### BACKGROUND OF THE INVENTION

1. Field of the Invention

The invention relates to a rubber dome, and more particularly, to a rubber dome manufacturing method which can simplify the manufacturing process and increase the production yield and a rubber dome manufactured by the method.

2. Description of the Prior Art

With the developing of the technology, the information equipment has also become popular. Taking the most-used computer for example, there are various kinds of computers on the market, and they are used in every place, such as a home, a factory, an office, and a school, and almost become a necessary apparatus in our daily life. A well-known computer, no matter a desktop computer or a notebook, needs a keyboard for a user to input words.

FIG. 1 and FIG. 2 respectively show an appearance view and an explosion view of a keyswitch 1 of an ordinary keyboard. As shown in FIG. 2, the keyswitch 1 includes a bottom plate 10, a thin-film circuit 12, a rubber dome 18, a cover 14, and a key cap 16. FIG. 3 shows a cross-sectional view of the keyswitch 1. As shown in FIG. 3, the thin-film circuit 12 is set on the bottom plate 10, and the rubber dome 18 is set on the thin-film circuit 12. A switch 120 is set on the thin-film circuit 12, and the rubber dome 18 includes a switch contact 182 corresponding to the switch 120.

When the key cap 16 is pushed by an external force and moves downward, a central rod 162 will press against a support rod 180 to cause the deformation of the rubber dome 18, so that the switch contact 182 of the rubber dome 18 will contact with the switch 120. In fact, the inputting function or other functions can be achieved according to whether the switch 120 of the thin-film circuit 12 contacts with the switch contact 182 of the rubber dome 18 or not.

Therefore, it is believed that the rubber dome 18 is one of the very important devices in the keyswitch 1 of the keyboard. Since the rubber dome 18 has hollow structure, in order to prevent the situation that it is not smooth when the user presses the keyswitch 1 due to the air in the inner space 184 of the rubber dome 18, therefore, an exhausting hole can be set on the top of the rubber dome 18, so that the air in the inner space 184 can be exhausted from the exhausting hole when the user presses the keyswitch 1.

Generally, in the conventional process of manufacturing a rubber dome including an exhausting hole, a rubber material is usually poured into the space formed by a top mold and a bottom mold, when the rubber material becomes solid, the rubber dome is done. Then, the exhausting hole will be made on the top of the rubber dome via a punching or laser processing method. The detailed steps are shown in FIG. 4.

However, the conventional process of manufacturing the rubber dome including the exhausting hole mentioned above is complicated and has poor production efficiency. Since the size of the rubber dome and the exhausting hole is designed smaller and smaller, it is harder to use the punching or laser processing method to generate the exhausting hole on the rubber dome, accordingly, the production yield of the rubber dome will be reduced.

Therefore, the invention provides a rubber dome manufacturing method capable of simplifying the manufacturing process and improving the production yield and a rubber dome made by the method to solve the above-mentioned problems in prior arts.

### SUMMARY OF THE INVENTION

The invention discloses a rubber dome and the manufacturing method thereof. The rubber dome has a hollow structure and an exhausting hole on its top, and the rubber dome is mainly applied in a keyswitch structure of a keyboard. With the rubber dome manufacturing method of the invention, the process of manufacturing the rubber dome can be effectively simplified, and the production yield of the rubber dome can be also improved. Since the rubber dome is an important device in the keyswitch structure of the keyboard, the cost of manufacturing the keyboard can be also reduced.

A first embodiment of the invention is a rubber dome manufacturing method. The rubber dome manufacturing method is used to automatically manufacture a rubber dome with an exhausting hole on its top.

In this embodiment, a first mold and a second mold having some special structures will be used in the rubber dome manufacturing method. The first mold includes a through hole passing through from a first top of the first mold to the first bottom. The through hole has a first section on the first top and a second section on a specific plane in the first mold. A protruding part is set on the second top of the second mold and the protruding part corresponds to the second section. In order to achieve the effect the invention wants to reach, therefore, the first section on the first top should be larger than the second section on the first bottom. In fact, the form of the through hole in the first mold can be a step form or a funnel form.

In the manufacturing process, firstly, the rubber dome manufacturing method connects a first bottom of a first mold and a second top of a second mold closely to form a specific space between the first bottom and the second top.

Then, the rubber dome manufacturing method pours a rubber material into the specific space. After a period of time goes by, the rubber dome manufacturing method separates the first mold and the second mold to get the rubber dome with the exhausting hole on its top. It should be noticed that when the first mold and the second mold are separated, a part of the rubber material is remained in the first mold.

A second embodiment of the invention is a rubber dome. The rubber dome is applied in a keyswitch structure of a keyboard. The rubber dome includes a rubber body and a hole. When a first bottom of a first mold and a second top of a second mold are closely connected, a specific space will be formed between the first bottom and the second top. Then, a rubber material is poured into the specific space; after a period of time goes by, the rubber material will form the rubber body. When the first mold and the second mold are separated, the hole will be automatically formed on the top part of the rubber body.

In this embodiment, the first mold and the second mold both have some special structures. The first mold includes a through hole passing through from a first top of the first mold to the first bottom. The through hole has a first section on the first top and a second section on a specific plane in the first mold. The first section on the first top should be larger than the second section on the first bottom, and the form of the through hole in the first mold can be a step form or a funnel form.

Additionally, a protruding part is set on the second top of the second mold and the protruding part corresponds to the second section. When the first mold and the second mold are separated, a part of the rubber material is remained in the first mold.

Compared to the prior arts, since the rubber dome and the manufacturing method thereof according to the invention can automatically generate the rubber dome with the exhausting hole on its top, no additional following exhausting hole manufacturing process is needed. Therefore, the rubber dome and the manufacturing method thereof according to the invention can effectively simplify the manufacturing process of the rubber dome and improve its production efficiency.

Moreover, the size of the rubber dome and the exhausting hole is designed smaller and smaller, in order to follow the trend of the smaller electronic product, it is harder to use the punching or laser processing method to generate the exhausting hole on the rubber dome. With the rubber dome manufacturing method of the invention, the rubber dome with the exhausting hole on its top can be automatically manufactured, and no following exhausting hole process is needed, therefore, the production yield of the rubber dome can be effectively improved.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1 shows an appearance view of a keyswitch of an ordinary keyboard.

FIG. 2 shows an explosion view of the keyswitch shown in FIG. 1.

FIG. 3 shows a cross-sectional view of the keyswitch shown in FIG. 1.

FIG. 4 shows the steps of the conventional method of manufacturing a rubber dome with an exhausting hole.

FIG. 5(A) and FIG. 5(B) respectively show the first mold and the second mold used to manufacturing the rubber dome in this invention.

FIG. 6 shows the flow chart of the rubber dome manufacturing method according to the first embodiment of the invention.

FIG. 7(A)˜FIG. 7(C) show the steps of the rubber dome manufacturing method shown in FIG. 6.

FIG. 8 shows the part of the rubber material remained in the first mold.

FIG. 9(A) and FIG. 9(B) respectively show a cross-sectional view and a top view of the rubber dome according to the second embodiment of the invention.

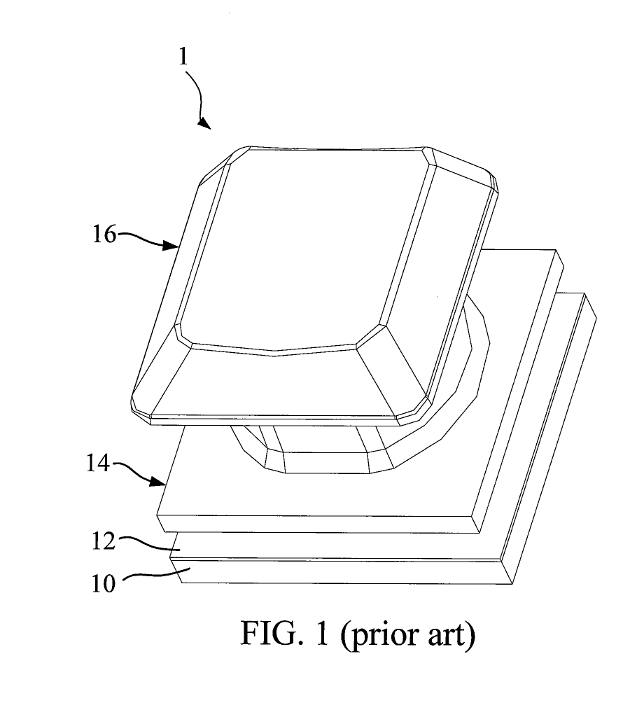

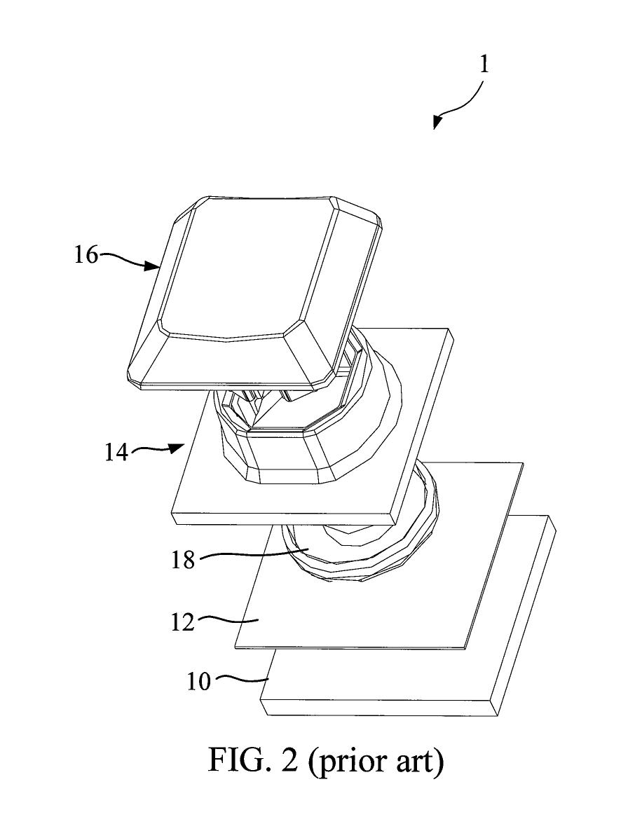

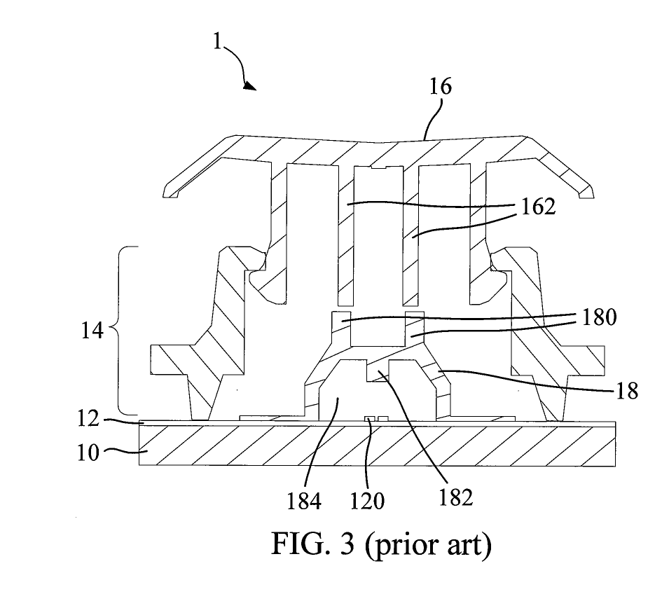

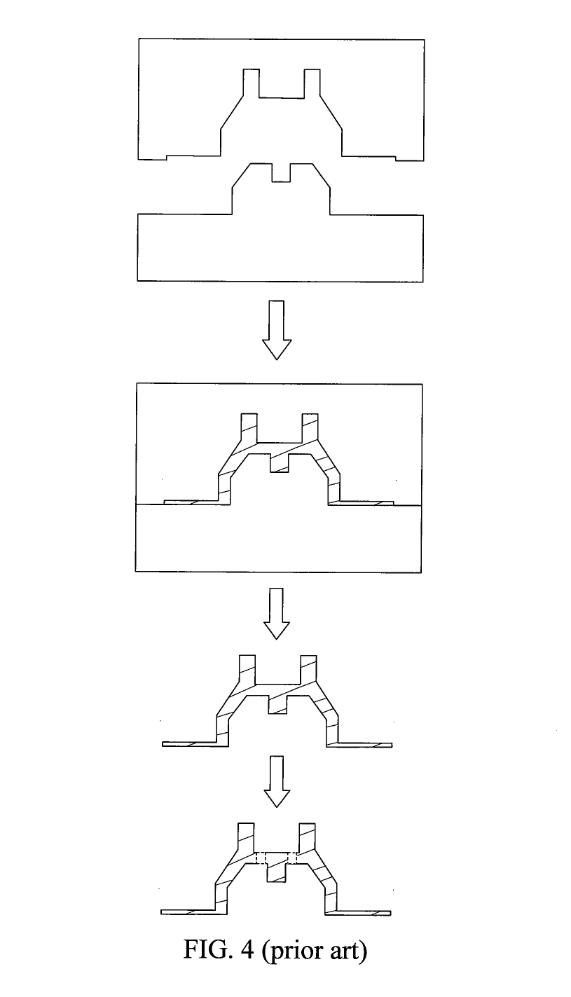

### DETAILED DESCRIPTION OF THE INVENTION

The invention provides a rubber dome and the manufacturing method thereof. The rubber dome has a hollow structure and an exhausting hole on its top, and the rubber dome is mainly applied in a keyswitch structure of a keyboard. With the rubber dome manufacturing method of the invention, the process of manufacturing the rubber dome can be effectively simplified, and the production yield of the rubber dome can be also improved. Since the rubber dome is an important device in the keyswitch structure of the keyboard, the cost of manufacturing the keyboard can be also reduced.

A first embodiment of the invention is a rubber dome manufacturing method. The rubber dome manufacturing method is used to automatically manufacture a rubber dome with an exhausting hole on its top.

In this embodiment, the rubber dome manufacturing method is used to manufacture a rubber dome with two exhausting holes on its top. In fact, the number and the size of the exhausting hole can be determined according to the practical needs, it is not limited to this case.

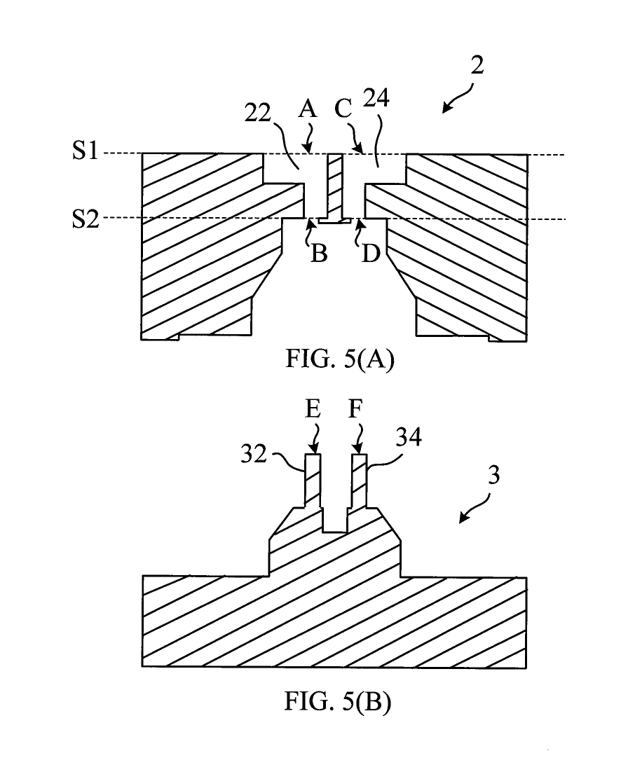

In this embodiment, a first mold and a second mold having some special structures will be used in the rubber dome manufacturing method. Please refer to FIG. 5(A) and FIG. 5(B). FIG. 5(A) and FIG. 5(B) respectively show the scheme diagrams of the first mold and the second mold. In fact, the molds used in the rubber dome manufacturing method can also have other similar structures and not limited to this case.

At first, the structure of the first mold will be introduced. As shown in FIG. 5(A), in order to manufacture the rubber dome with two exhausting holes on its top, the first mold 2 includes a first through hole 22 and a second through hole 24, and the first through hole 22 and the second through hole 24 are symmetrical. The first through hole 22 passes through from the top of the first mold 2 to the bottom of the first mold 2.

It should be noticed that the first through hole 22 has a first section A on a plane S1 of the top of the first mold 2 and a second section B on a plane S2 in the first mold 2. In order to achieve the effect the invention wants to reach, the first section A should be larger than the second section B.

In fact, the form of the first through hole 22 between the first section A and the second section B can be a step form, a funnel form, or other forms in accordance with that the first section A is larger than the second section B.

Similarly, the second through hole 24 also passes through from the top of the first mold 2 to the bottom of the first mold 2. The second through hole 24 has a third section C on the plane S1 of the top of the first mold 2 and a fourth section D on the plane S2 in the first mold 2. In order to achieve the effect the invention wants to reach, the third section C should be also larger than the fourth section D. In fact, the form of the second through hole 24 between the third section C and the fourth section D can be a step form, a funnel form, or other forms in accordance with that the third section C is larger than the fourth section D.

Next, the structure of the second mold will be introduced. As shown in FIG. 5(B), in order to manufacture the two exhausting holes on the top of the rubber dome, a first protruding part 32 and a second protruding part 34 are set on the top of the second mold 3.

It should be noticed that the position of the first protruding part 32 will correspond to the second section B of the first mold 2; the position of the second protruding part 34 will correspond to the fourth section D of the first mold 2.

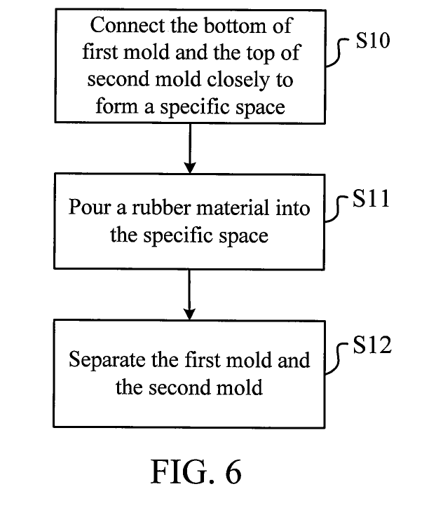

Then, the steps of the method of manufacturing the rubber dome with two exhausting holes on its top will be introduced in detail. Please refer to FIG. 6. FIG. 6 shows the flow chart of the rubber dome manufacturing method.

As shown in FIG. 6, firstly, the rubber dome manufacturing method performs step S10 to connect the bottom of the first mold 2 and the top of the second mold 3 closely to form a specific space between the first mold 2 and the second mold 3.

Then, the rubber dome manufacturing method performs step S11 to pour a rubber material used to form the rubber dome into the specific space. After a period of time goes by, the rubber material will become solid in the specific space to form the rubber dome. At this time, the rubber dome manufacturing method performs step S12 to separate the closely connected first mold 2 and second mold 3, and the rubber dome with two exhausting holes on its top will be formed.

It should be noticed that when the first mold 2 and the second mold 2 are separated, since there could be some rifts existed between the first mold 2 and the second mold 2, the rims of the two exhausting holes on the top of the rubber dome could be attached by a layer of rubber thin film, but the exhausting function of the exhausting holes will not be affected.

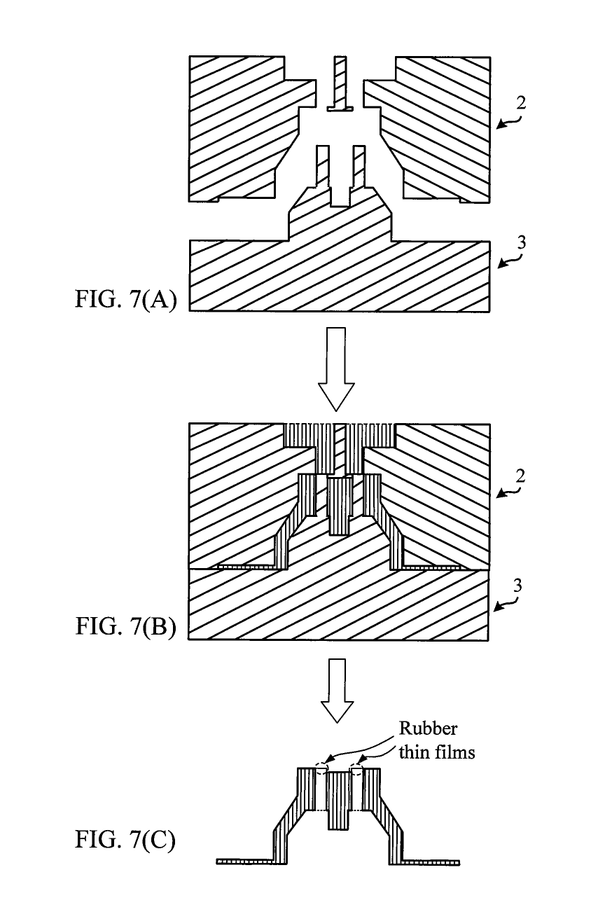

In order to express the steps of the rubber dome manufacturing method more clearly, please refer to FIG. 7(A)˜FIG. 7(C), FIG. 7(A)˜FIG. 7(C) respectively show the scheme diagrams of the steps of the rubber dome manufacturing method.

As shown in FIG. 7(A), the first mold (the upper mold) 2 and the second mold (the bottom mold) 3 are used in the rubber dome manufacturing method. After the bottom of the first mold 2 and the top of the second mold 3 are closely connected, the specific space will be formed between the first mold 2 and the second mold 3.

Then, the rubber material is poured into the specific space, as shown in FIG. 7(B). After a period of time goes by, the rubber material in the specific space will become solid to form the rubber dome. At this time, the first mold 2 and the second mold 3 can be separated to get the rubber dome with two exhausting holes on its top.

However, in practical applications, since there could be some rifts existed between the first mold 2 and the second mold 2, the rims of the two exhausting holes on the top of the rubber dome could be attached by a layer of rubber thin film, but the exhausting function of the exhausting holes will not be affected, as shown in FIG. 7(C).

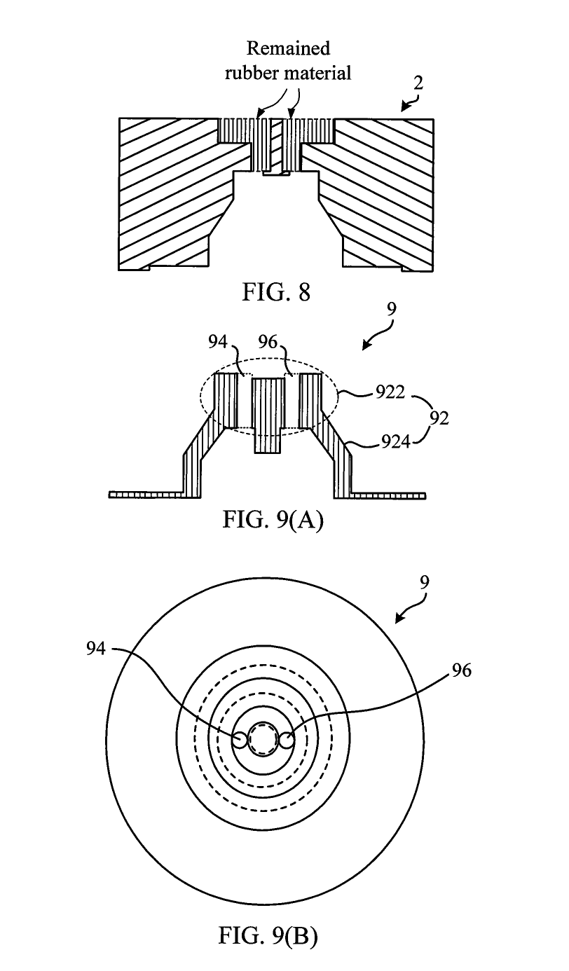

It should be noticed that when the first mold 2 and the second mold 3 are separated, there will still a part of the rubber material remained in the first mold 2, as shown in FIG. 8. It is unnecessary to remove the remained rubber material, because the remained rubber material can be reused in the next rubber dome manufacturing process, so that the amount of the rubber material used can be reduced, and the cost of manufacturing the rubber dome can be also reduced.

Above all, in this embodiment, the rubber dome manufacturing method of the invention can directly manufacture the rubber dome with the top exhausting hole via the special designed molds only, no additional following exhausting hole manufacturing process is needed. Therefore, the rubber dome manufacturing method of the invention can effectively simplify the process of manufacturing the rubber dome and increase the production yield of the rubber dome, the total cost of the entire keyboard can be also reduced accordingly.

A second embodiment of the invention is a rubber dome. The rubber dome with hollow structure is applied in a keyswitch structure of a keyboard, and it is one of the important devices in the keyswitch structure. Please refer to FIG. 9(A) and FIG. 9(B). FIG. 9(A) and FIG. 9(B) respectively show a cross-sectional view and a top view of the rubber dome according to the second embodiment of the invention.

As shown in FIG. 9(A) and FIG. 9(B), the rubber dome 9 includes a rubber body 92, a first hole 94, and a second hole 96, wherein the rubber body 92 has a top part 922 and a ring side 924; the first hole 94 and the second hole 96 are set on the top part 922 and used as the exhausting holes of the rubber dome 9.

Then, the molds used to manufacture the rubber dome 9 will be introduced. Please also refer to FIG. 5(A) and FIG. 5(B). FIG. 5(A) and FIG. 5(B) respectively show the scheme diagrams of the first mold and the second mold.

As shown in FIG. 5(A), the first mold 2 includes a first through hole 22 and a second through hole 24, and the first through hole 22 and the second through hole 24 are symmetrical. The first through hole 22 has a first section A on a plane S1 of the top of the first mold 2 and a second section B on a plane S2 in the first mold 2. The first section A should be larger than the second section B. In fact, the form of the first through hole 22 between the first section A and the second section B can be a step form, a funnel form, or other forms.

Similarly, the second through hole 24 has a third section C on the plane S1 of the top of the first mold 2 and a fourth section D on the plane S2 in the first mold 2. The third section C should be also larger than the fourth section D. In fact, the form of the second through hole 24 between the third section C and the fourth section D can be a step form, a funnel form, or other forms.

As shown in FIG. 5(B), a first protruding part 32 and a second protruding part 34 are set on the top of the second mold 3. The position of the first protruding part 32 will correspond to the second section B of the first mold 2; the position of the second protruding part 34 will correspond to the fourth section D of the first mold 2.

Then, when the bottom of the first mold 2 and the top of the second mold 3 are closely connected, a specific space will be formed between the first mold 2 and the second mold 3. Afterward, a rubber material is poured into the specific space; after a period of time goes by, the rubber material will become solid to form the top part 922 and the ring side 924 of the rubber body 92 of the rubber dome 9. Because the special designed structure of the first mold 2 and the second mold 3, when the first mold 2 and the second mold 3 are separated, the first hole 94 and the second hole 96 will be automatically formed on the top part 922 of the rubber body 92.

It should be noticed that when the first mold 2 and the second mold 3 are separated, there will be still a part of the rubber material remained in the first mold 2, as shown in FIG. 8. It is unnecessary to remove the remained rubber material, because the remained rubber material can be reused in the next rubber dome manufacturing process, so that the amount of the rubber material used can be reduced, and the cost of manufacturing the rubber dome can be also reduced.

Compared to the prior arts, since the rubber dome and the manufacturing method thereof according to the invention can automatically generate the rubber dome with the exhausting hole on its top, no additional following exhausting hole manufacturing process is needed. Therefore, the rubber dome and the manufacturing method thereof according to the invention can effectively simplify the manufacturing process of the rubber dome and improve its production efficiency.

Moreover, the size of the rubber dome and the exhausting hole is designed smaller and smaller, in order to follow the trend of the smaller electronic product, it is harder to use the punching or laser processing method to generate the exhausting hole on the rubber dome. With the rubber dome manufacturing method of the invention, the rubber dome with the exhausting hole on its top can be automatically manufactured, and no following exhausting hole process is needed, therefore, the production yield of the rubber dome can be effectively improved.

Although the present invention has been illustrated and described with reference to the preferred embodiment thereof, it should be understood that it is in no way limited to the details of such embodiment but is capable of numerous modifications within the scope of the appended claims.

What is claimed is:

1. A method of manufacturing a rubber dome, comprising the steps of:
(a) connecting a first bottom of a first mold and a second top of a second mold closely to form a specific space between the first bottom and the second top;
(b) pouring a rubber material into the specific space; and
(c) after a period of time goes by, separating the first mold and the second mold to get the rubber dome comprising at least one hole formed by the rubber material;
wherein the first mold comprises a through hole passing through from a first top of the first mold to the first bottom, the through hole has a first section on the first top and a second section on a specific plane in the first mold, the first section is larger than the second section, a protruding part is set on the second top and the protruding part corresponds to the second section.

2. The method of claim 1, wherein the rubber dome is applied in a keyswitch structure.

3. The method of claim 1, wherein the rubber dome has a hollow structure.

4. The method of claim 1, wherein the at least one hole is located on the top of the rubber dome.

5. The method of claim 1, wherein the at least one hole is used to exhaust.

6. The method of claim 1, wherein the form of the through hole in the first mold is a step form or a funnel form.

7. The method of claim 1, wherein in step (c), when the first mold and the second mold are separated, a part of the rubber material is remained in the first mold.

8. A rubber dome, comprising:
a rubber body, the rubber body having a top part and a ring side, wherein when a first bottom of a first mold and a second top of a second mold are closely connected, a specific space being generated between the first bottom and the second top, after a rubber material is poured into the specific space and a period of time goes by, the rubber material forming the top part and the ring side of the rubber body; and
a hole, when the first mold and the second mold are separated, the hole being automatically formed on the top part.

9. The rubber dome of claim 8, being applied in a keyswitch structure.

10. The rubber dome of claim 8, having a hollow structure.

11. The rubber dome of claim 8, wherein the hole is used to exhaust.

12. The rubber dome of claim 8, wherein when the first mold and the second mold are separated, a part of the rubber material is remained in the first mold.
